(19) United States
(12) Patent Application Publication
(10) Pub. No.: US 2007/0198510 A1
(43) Pub. Date: Aug. 23, 2007

(54) Method and system for assigning customer influence ranking scores to internet users

(75) Inventor: Gordon A. Ebanks, New York, NY (US)

Correspondence Address: BROOKS KUSHMAN P.C., 1000 TOWN CENTER, TWENTY-SECOND FLOOR, SOUTHFIELD, MI, 48075, US

(73) Assignee: Customerforce.com, New York, NY (US)

(21) Appl. No.: 11/699,868

(22) Filed: Jan. 30, 2007

Related U.S. Application Data
(60) Provisional application No. 60/765,394, filed on Feb. 3, 2006.

(51) Int. Cl. G06F 17/30

(52) U.S. Cl. 707/5

(57) ABSTRACT

A method and system for assigning ranking scores to Internet users of a networking site and a content site in which the networking site enables each user to become associated with other users as friends and in which the content site enables each user to rate content published by other users includes the following operations. Data indicative of the friends of each user is obtained from the networking site and a network popularity rating is assigned to each user based on this data. Data indicative of the ratings assigned to the published content of the users is obtained from the content site and a content popularity rating is assigned to each user based on this data. A ranking score is assigned to each user based on the network popularity and content popularity ratings of the user. The ranking scores are provided to a third party.

### CROSS-REFERENCE TO RELATED APPLICATIONS

This application claims the benefit of U.S. Provisional Application No. 60/765,394, filed Feb. 3, 2006, which is hereby incorporated by reference in its entirety.

### BACKGROUND OF THE INVENTION

1. Field of the Invention

The present invention relates to assigning customer influence ranking scores to on-line users such as Internet users of social networking sites and user generated media sites.

2. Background Art

A social networking site is an on-line (i.e., Web, Internet, etc.) site that provides a virtual community for on-line users. Typically, users of social networking sites are members of the sites and are interested in common subjects to which the sites are dedicated. Social networking sites provide a medium for its users to interact (via blogs, instant message, e-mail, etc.) with other users about shared interests and points of discussion. Users become members of a social networking site either by invitation of other users or, alternatively, the site is open to the general public.

Social networking includes a concept that a user's on-line personal network of friends, family, colleagues, co-workers, and the subsequent connections within those networks, can be used to find more relevant connections for making purchases, selecting restaurants, dating, employment, service referrals, activity partners, and the like. Because individuals are more likely to trust and value the opinions from people they know than from strangers, social networking is typically directed towards mining these network relationships in a way that is often more difficult to do off-line.

Social networking sites typically allow their users to create personal social networks. A personal social network of a user may include other users who are “friends” of the user. In a personal network, a user and the user's friends communicate and share information with one another without other users being privy to such communications and information. Each user is associated with a file which is populated with the user's friends. Typically, the user and/or the user's friends belong to other personal networks in a social networking site. For example, a first personal network includes first and second users and a second personal network includes the first user and a third user. In this case, the second user is a “friend of a friend” (FOAF) of the third user with FOAF being the first user, and second and third users have one degree of separation in a FOAF file. The third user may further belong to a third personal network which includes a fourth user. In this case, the second and fourth users are FOAF with two degrees of separation.

As such, users of a social networking site are interconnected with one another even though the users belong to different personal networks of the social networking site. The interconnection between users is a function of the FOAF degrees. Two users (i.e., two friends) of a personal network are more interconnected than two users who are FOAF of one another. Likewise, two users who have two degrees of FOAF separation are more interconnected than two users who have three or more degrees of FOAF separation. As such, a set of users are more “connected” with other users in an on-line manner as the set of users belong to diverse personal networks, belong to more personal networks, belong to bigger personal networks, have more friends, have more closer friends, have more friends who have other friends, etc. Likewise, a set of users are more connected with other users in an on-line manner as the set of users belong to different social networking sites, have more friends, etc. Generally, the popularity of a user of a social networking site(s) is proportional to the amount of connectivity that the user has with other users of the social networking site(s).

Users use on-line user generated sites such as blogs in order to write, submit, “post”, etc., information for other on-line users to access. In general, a blog is a website provided by a blog provider in which a user operator of the blog publishes journal entries, articles, etc., about subjects of interest to the user operator for other users to read and perhaps post responses. For example, a professional football player may have a personal blog in which the player posts an entry about his team for user fans to read. The blog provides a forum for the fans to post responses such as “great game” for the player and other fans to read. Similarly, a consumer product reviewer may have a blog in which the reviewer posts entries about consumer products for consumers to read. Consumers may be interested in purchasing the products and, as such, are inquisitive about what the reviewer and other consumers have to say about the products. The blog enables consumers to post entries regarding the products for the reviewer and other consumers to access or read.

The popularity of a website such as a blog is a measurable quantity. For instance, a blog which is accessed by many users and/or has entries posted by many users is more popular than a blog which is accessed by few users and/or has entries posted by few users. As such, the operator of a popular blog is more “connected” with on-line users than the operator of a non-popular blog. Likewise, the popularity of blog users is also a measurable quantity. For example, blog users may be rated, for example, by other users, as a function of the relative popularity of their posted entries. As such, some blog users are more “connected” than other users as these blog users have their own popular blogs, post popular entries in other blogs, etc. Again, generally, the popularity of a blog user (i.e, a blog operator or a user of blog) is proportional to the amount of connectivity that the user has with other blog users.

In general, social networking sites and consumer generated media sites (i.e., blogs) provide mediums through which viral word-of-mouth marketing can take place. Sellers of goods and services recognize the power of word-of-mouth marketing by realizing that people are more likely to purchase goods and services based on recommendations of people they trust rather than based on advertisements, expert opinions, or spam email. Additionally, new privacy laws are making sellers aware of anti-spamming regulations and the importance of buyer privacy. As such, it is desirable to identify the most popular (i.e, most connected) Internet users such as users of social networking sites and user generated media sites (such as blogs) as these users likely have the most influence on purchasing decisions made by other users.

### SUMMARY OF THE INVENTION

It is an object of the present invention to provide a method and system for assigning customer influence ranking scores to Internet users.

In carrying out the above object and other objects, the present invention provides a method for assigning ranking scores to Internet users of a networking site and a content site. The networking site enables each user to become associated with one or more other users as friends. The content site enables each user to rate content published on the content site by other users. The method includes obtaining data indicative of the friends of each user from the networking site and assigning a network popularity rating to each user based on the amount of friends of the user. The method further includes obtaining data indicative of the ratings assigned to the published content of the users from the content site and assigning a content popularity rating to each user based on the ratings of the content published by the user. The method further includes assigning a ranking score to each user based on the network popularity rating and the content popularity rating of the user and providing the ranking scores of the users to a third party.

In carrying out the above object and other objects, the present invention provides a system for assigning ranking scores to Internet users. The system includes a social network server for providing a social networking site for use by Internet users. The social networking site enables each user to become associated with one or more other users as friends. The system further includes a media content server for providing a media content site for use by the users. The media content site enables each user to publish content for the other users to view. The media content site enables each user to rate the content published by other users. The system further includes a score provider server in communication with the social network server to enable a score provider to obtain a first set of data indicative of the friends of each user. The score provider assigns a social network popularity rating to each user based on the amount of friends of the user. The score provider server is in communication with the media content server to enable the score provider to obtain a second set of data indicative of the ratings assigned to the published content of the users. The score provider assigns a media content popularity rating to each user based on the ratings of the content published by the user. The score provider assigns a ranking score to each user based on the social network popularity rating and the media content popularity rating of the user and provides the ranking score of the users to a third party.

In accordance with the above object and other objects, the present invention provides a method and system which assign to Internet (i.e., Web, on-line, etc.) users customer influence ranking scores indicative of the on-line influence that the users have with other users. In accordance with the present invention, the on-line influence that a user has with other users is proportional to the popularity of the user with the other users. For example, a user who is popular with other users has more on-line influence than a user who is not popular with the other users.

In accordance with the present invention, the popularity of a user with other users is proportional to the on-line “connectivity” that the user has with the other users. As such, a user who is connected in an on-line manner with many users is more popular (and has more on-line influence) amongst other users than a user who is connected in an on-line manner with few users. The on-line connectivity that a user has with other users depends on such factors as (i) the social networking breadth of the user and (ii) the reach (relevance) of on-line publishing generated by the user. For example, with respect to (i), a first user of a social networking site has more on-line connectivity than a second user of the social networking site if more users of the social networking site identify the first user as a friend than the amount of users of the social networking site who identify the second user as a friend. For example, with respect to (ii), a user operator of a web site such as blogging site has more on-line connectivity than users of the blogging site as the user operator is the creator of the blogging site whereas the other users simply access and post entries to the blogging site. Likewise, a first user of a web site such as a blogging site has more on-line connectivity than a second user of the blogging site if the first user posts more popular entries to the blogging site.

Social networking sites and consumer generated media sites (blogging, etc.) enable viral word-of-mouth marketing. Word-of-mouth marketing takes place, for example, when a first consumer tells another consumer about a manufacturer's product. Most of the time, the first consumer has purchased and used the product and then tells the other consumer about the first consumer's experience with the product. The other consumer may then decide whether to purchase the product based on what the first consumer had to say. Likewise, the other consumer may tell other consumers what the first consumer had to say and these other consumers may also base their decision on what the first consumer had to say. Viral word-of-mouth marketing is enabled through the use of social networking sites and consumer generated media sites as the first consumer is able to tell a relatively large group of consumers about the product. That is, what the first consumer has to say about the product is immediately accessible by many other consumers with the first user having simply done no more than what it would have taken to tell one user about the product. Social networking sites and consumer generated media sites themselves are being used by more and more users. As such, the rise of social networking sites and consumer generated media sites along with the viral word-of-marketing enabled by these sites combine to emphasize the increasing power of consumers. That is, power is moving to consumers and maximum power resides with the consumers yielding the most on-line influence.

Accordingly, it is desirable to identify the users who have the most on-line influence with other users. Further, it is desirable to identify the amount of on-line influence that a given user has with other users. In turn, it is desirable to provide information regarding the on-line influence of users to sellers of goods and services because each user is a potential “mouthpiece” for the seller and the users which have the most on-line influence are the biggest potential mouthpieces. With knowledge of the on-line influence that users possess, sellers can provide purchasing discounts for goods or services (or perhaps simply give away the goods or services) to the users who have the most on-line influence with the understanding that these users can and probably will influence the purchasing decisions made by other users.

In accordance with the present invention, as indicated above, the on-line connectivity that an on-line user has with other on-line users is determined as a function of (i) the social networking breadth of the user and (ii) the reach (relevance) of on-line publishing generated by the user. The user is then assigned a customer influence ranking score based on the determined connectivity of the user. Again, the amount of connectivity that a user has with other users is proportional to the popularity of the user which, in turn, is proportional to the influence that the user has with other users. The customer influence ranking score assigned to a user is also referred to herein as a Customerforce™ score.

The customer influence ranking score of a user reflects the ability of the user to publish: (i) personal messages to a trusted group that has a wide distribution (i.e., the social networking breadth of the user); and (ii) public content that has a wide distribution (i.e., the reach or relevance of on-line publishing generated by the user).

In general, a customer influence ranking score works like a FICO credit score but in reverse. That is, like the FICO credit score rankings in which individuals with the highest credit scores are eligible to get the best and lowest loan rates from loan providers, individuals with the highest customer influence ranking scores are eligible to get the most attractive on-line purchasing discounts for goods and services from sellers of the goods and services. Many sellers of goods and services want to get their goods and services to the consumers which have the greatest influence on other consumers. As such, armed with the knowledge of customer influence ranking scores of on-line users, sellers such as manufacturers of goods can offer attractive discounts for their goods to the users having the greatest customer influence ranking scores in order to get their goods to these users. The customer influence ranking scores of a group of users can be used to negotiate volume discounts with sellers such as manufacturers and retailers.

In reality, the affiliation of the most influential or powerful consumers cannot be bought. However, it is still advantageous for sellers such as manufacturers of goods to have knowledge of which on-line users have the most influence on other users. This is because sellers are able to increase the power of their word-of-mouth campaigns by reaching the users which have the most influence in their category offerings. An on-line user having a high customer influence ranking score is an ideal candidate for word-of-mouth campaigns of sellers. As such, the sellers would entitle such users to special offers and discounts because of their status. Accordingly, assigning customer influence ranking scores to on-line users, who are in turn consumers or potential consumers, enables sellers such as companies to make offers to the consumers who are really interested in receiving them as well as reaching those consumers who have the most on-line influence on other on-line consumers.

An on-line user is able to increase its customer influence ranking score by becoming more connected with other users. For example, an on-line user can become more connected with other users by joining more on-line networks and being more interconnected to other users of these networks (i.e., increasing the user's social networking breadth). Likewise, for example, an on-line user can become more connected with other users by having a greater reach and relevancy of their user generated content as a result of posting on more customer forum sites, joining more on-line groups, creating a blog, linking to popular blogs and in turn becoming more popular and influential, etc. (i.e., increasing the user's reach and relevancy of its on-line publishing).

As such, the customer influence ranking score system is based on the hypothesis that some consumers are more attractive to sellers such as manufacturers and retailers. Namely, the most attractive consumers are on-line users which have the greatest influence on other on-line users. The customer influence ranking score for each on-line user is an absolute number. Force distribution may be used to group customer influence ranking scores into performance bands, for example, and the universe of users assigned such scores are ranked according to their scores with the top 20% getting the highest score, the next 20% getting the next score, and so on.

Again, in accordance with the present invention, the customer influence ranking score for an on-line user is a function of two components or variables: (i) the social networking breadth of the user and (ii) the reach (relevance) of on-line publishing generated by the user. These two components may be weighted evenly or unevenly. Further, the weighting between these two components may also be adjusted over time.

The social networking breadth component for the user is a measure of the user's “community” connectivity. The social networking breadth component of the user is formed from different sub-components such as the number of entries in the user's friend of a friend (FOAF) file associated with a social networking site(s); the number of entries in second (third, and fourth) degree FOAF file; the extended number of entries in the user's address book (e.g., Plaxo, Outlook, Yahoo!, etc.); etc. As can be appreciated, the sub-components making up the social networking breadth of the user may be weighted differently. For example, the sub-component representing the number of entries in the user's FOAF file may have a greater weighting than the sub-component representing the number of entries in the user's second degree FOAF file. These social networking breadth sub-components are measured based on publicly available social networking information (e.g., size of and extended XML based FOAF files).

The component indicative of the reach (relevance) of on-line publishing generated by the user is a measure of the user's “publishing” connectivity. This component is formed from different sub-components such as number of posts (blogs, groups, forums, listservs, Reviews); relative popularity of blog posts or user reviews (user ratings, relative popularity of blogs); the relative popularity of the blogs of the other users who link to those blogs; relative popularity of user reviews (uses ratings and rankings); personal website Alexa rankings; blog page views; and relative popularity of these forums. Again, as can be appreciated, these sub-components making up the publishing breadth of the user can be weighted differently. These on-line publishing sub-components are measured based on publicly available ranking scores for user generated media (e.g., blog rankings, website rankings)—all of the blog information and rankings are publicly available.

In sum, the customer influence ranking score for an on-line user is a function of the social networking breadth of the user (i.e., community connectivity of the user) and the reach (relevance) of on-line publishing generated by the user (i.e., publishing connectivity of the user). The community connectivity (i.e. “Breadth”) of a user is based on publicly available social networking site information (e.g., size of and extended XML based FOAF files) whereas the publishing connectivity (i.e., “Relevance”) of a user is based on publicly available ranking scores for user generated media. The weighting between the two components making up the customer influence ranking score of an on-line user, namely, the social networking breadth component (Breadth) and the on-line user generated publishing component (Relevance) can be determined empirically over time and additional factors can also be included to determine the customer influence ranking score for the user.

In operation, individual social networking forums, bulletin boards, blog providers, etc., register their services with a customer influence ranking score provider. These entities register their services in a manner similar to the method used for indexing web pages. Sellers of goods and services such as companies that do not register with the customer influence ranking score provider do so at the risk of relegating their services to obscurity. Web crawlers aggregate the information regarding the sub-components indicative of the connectivity of on-line users (i.e., information regarding the sub-components indicative of the breadth and relevance of on-line users) periodically. The web crawlers aggregate such information in a manner similar to web search algorithms and provide the aggregated information to the customer influence ranking score provider. In turn, the customer influence ranking score provider assigns customer influence ranking scores to the users based on the aggregated information. Thus, a social network or blog service provider registers with the customer influence ranking score provider to become a recognized partner to be included in ranking and members (i.e., on-line users) would then be exposed to those customer influence ranking score providers to increase their ranking.

### BRIEF DESCRIPTION OF THE DRAWINGS

FIG. 1 illustrates a block diagram illustrating one embodiment of an environment for practicing the present invention; and

FIG. 2 illustrates a flowchart describing operation of the method and system in accordance with the present invention.

### DETAILED DESCRIPTION OF THE PREFERRED EMBODIMENT(S)

The present invention now will be described more fully hereinafter with reference to the accompanying drawings, which form a part hereof, and which show, by way of illustration, specific exemplary embodiments by which the present invention may be practiced. The present invention may, however, be embodied in many different forms and should not be construed as limited to the embodiments set forth herein; rather, these embodiments are provided so that this disclosure will be thorough and complete, and will fully convey the scope of the present invention to those skilled in the art. Among other things, the present invention may be embodied as methods or systems. Accordingly, the present invention may take the form of an entirely hardware embodiment, an entirely software embodiment, or an embodiment combining software and hardware aspects. The following detailed description is, therefore, not to be taken in a limiting sense. The phrase “in one embodiment,” as used herein does not necessarily refer to the same embodiment, although it may. Similarly, the phrase “in another embodiment,” as used herein does not necessarily refer to a different embodiment, although it may. The term “based on” is not exclusive and provides for being based on additional factors not described, unless the context clearly dictates otherwise.

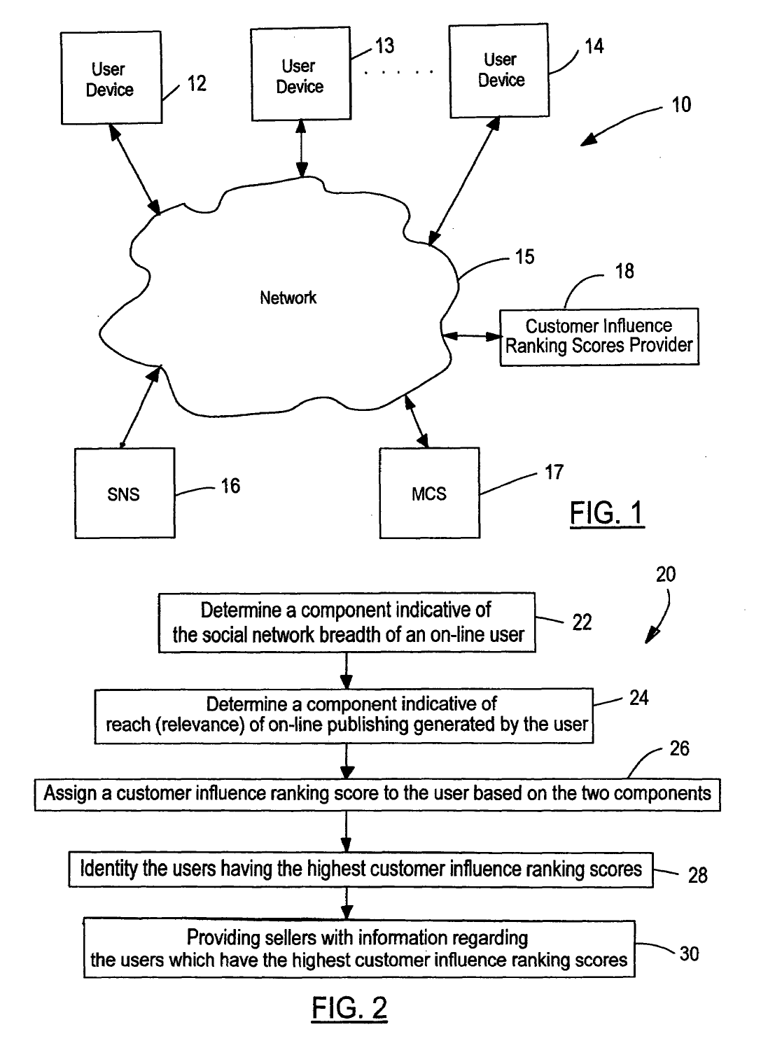

Referring now to FIG. 1, a block diagram illustrating one embodiment of an environment 10 for practicing the present invention is shown. It is noted that not all of these components may be required to practice the present invention, and variations in the arrangement and type of the components may be made without departing from the spirit or scope of the present invention. As shown in FIG. 1, environment 10 includes user devices 12, 13, 14, a network (i.e., the Internet) 15, a social networking site server (SNS) 16, a user generated media content site server (MCS) 17, and a user device of a customer influence ranking score provider 18. Network 15 is in communication with and enables communication between each of user devices 12, 13, 14, SNS 16, MCS 17, and score provider 18.

The user devices may include virtually any computing device capable of receiving and sending a message over a network, such as network 15, to and from another computing device, such as SNS 16 and MCS 17, each other, and the like. The set of such user devices may include devices that typically connect using a wired communications medium such as personal computers, multiprocessor systems, microprocessor-based or programmable consumer electronics, network PCs, and the like. The set of such user devices may also include devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, the user devices may be any device that is capable of connecting using a wired or wireless communication medium such as a PDA, POCKET PC, wearable computer, and any other device that is equipped to communicate over a wired and/or wireless communication medium.

Each user device 12, 13, 14 may include a browser application that is configured to receive and to send web pages, and the like. The browser application may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like.

User devices 12, 13, 14 may be further configured to receive a message from the another computing device employing another mechanism, including, but not limited to email, Short Message Service (SMS), Multimedia Message Service (MMS), instant messaging (IM), internet relay chat (IRC), mIRC, Jabber, and the like. User devices 12, 13, 14 may be further configured to enable a user to manage a user profile, category information, activity participation, and the like, which may in turn be saved at a remote location, such as SNS 16 and MCS 17, and the like.

Network 15 is configured to couple one computing device to another computing device to enable them to communicate. Network 15 is enabled to employ any form of computer readable media for communicating information from one electronic device to another. Also, network 15 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 15 includes any communication method by which information may travel between user devices 12, 13, 14, SNS 16, MCS 17, and score provider 18.

SNS 16 may include any computing device capable of connecting to network 15 in order to provide social networking sites for access by users of user devices 12, 13, 14. Similarly, MCS 17 may include any computing device capable of connecting to network 15 to provide user generated media content sites for access by users of user devices 12, 13, 14. Devices that operate as SNS 16 and MCS 17 include personal computers desktop computers, multiprocessor systems, microprocessor-based or programmable consumer electronics, network PCs, servers, and the like. Score provider 18 may include any computing device capable of connecting to network 15 in order to receive information regarding the on-line connectivity of users of user devices 12, 13, 14.

SNS 16 may be configured to receive information associated with a user of a user device. The received information may include, but is not limited to, profile information, category information, an activity, membership information associated with a category, and the like. SNS 16 associates a “friend” file with each user of a social networking site. Users can populate their friend file with other users of the social networking site who are friends of the users. A friend of a user may be another user that has common category, activity, or membership information with the user or is simply a user which has been designated by the user to have friend status. In turn, SNS 16 enables a user and its friends to communicate and share information with one another using their user devices without other users of the social networking site being privy to such information. As such, SNS 16 enables personal social networks of the social networking site to exist. A personal social network includes a user and the user's friends. Typically, users belong to different personal social networks. As a result, two users in two separate personal social networks may have a common friend who belongs to both personal social networks. In this case, the two users are friend-of-a-friend (FOAF) on one another with the FOAF being the common friend. These two users are have one degree of FOAF separation between them. User of a social networking site may have one or more degrees of FOAF separation between them. SNS 16 is configured to associate a FOAF file with each user and to populate the FOAF file of each user with FOAF entries. The FOAF entries for each user include first, second, third, and fourth FOAF degrees of separation. SNS 16 is also configured to associate an address book with each user such that the user can populate its address book with entries indicative of other users.

MCS 17 enables a blog provider to provide blogging sites for operators and users of user devices to access. An operator of a blogging site is the user that sets up the blogging site whereas other users of the blogging site simply access the blogging site. The operator uses a user device to publish on-line journal entries, articles, etc., about subjects of interest to the user operator for other users to read and perhaps post responses using their user devices. The blogging operator and the users are able to access the posts submitted to the blogging site. As such, the blog operator provides on-line publishing by submitting posts to a blogging site. Likewise, the users of the blogging site provide on-line publishing by posting responses to the posts.

Referring now to FIG. 2, with continual reference to FIG. 1, a flowchart 20 describing operation of a method and system for assigning to the users of the user devices customer influence ranking scores indicative of the on-line influence that the users have with other users is shown. In general, the on-line influence that a user has with other users is proportional to the on-line “connectivity” that the user has with the other users. The on-line connectivity that a user has with other users is based on (i) the social networking breadth of the user and (ii) the reach (relevance) of on-line publishing generated by the user. As such, the customer influence ranking score of a user reflects the ability of the user to publish: (i) personal messages to a trusted group that has a wide distribution (i.e., the social networking breadth of the user); and (ii) public content that has a wide distribution (i.e., the reach or relevance of on-line publishing generated by the user).

Score provider 18 obtains publicly available information indicative of the social networking breadth of the user and publicly available information indicative of the reach (relevance) of on-line publishing generated by the user to determine a customer influence ranking score for the user. In turn, score provider 18 may provide the customer influence ranking scores for the users along with publicly available information identifying the users to sellers of goods and services. Score provider 18 may rank the users in terms of their customer influence ranking scores in order to identify those users having the most on-line connectivity and pass this information along to the sellers. Sellers are desirous of such information in order to provide their goods and services to the users having the most on-line connectivity with the hope that these users will, as a result of their high “connectiveness” with other users, positively influence the purchasing decisions of the other users.

In operation, score provider 18 determines the social networking breadth of a user of a user device as shown in block 22. The social networking breadth component for a user is a measure of the user's “community” connectivity. The social networking breadth component of a user reflects the ability of the user to publish personal messages to a trusted group that has a wide distribution. The social networking breath component of a user is measured or determined by using publicly available social networking information (e.g, size of and extended XML-based FOAF files, etc.). Alternatively or additionally, SNS 16 may register its social networking forum services with score provider 18 to provide the social networking information associated with the user to the score provider. In a manner similar to web search algorithms, web crawlers can aggregate this information periodically. The social networking information associated with a user is based on several sub-components such as the number of entries in the user's FOAF file associated with a social networking site(s); the number of entries in second (third, and fourth) degree FOAF file; the extended number of entries in the user's address book (e.g., Plaxo, Outlook, Yahoo!, etc.); etc. Score provider 18 may weigh these sub-components differently. Again, these social networking breadth sub-components are measured based on publicly available social networking information.

Score provider 18 determines the reach (relevance) of on-line publishing generated by the user as shown in block 24. This component, which is indicative of the reach (relevance) of on-line publishing generated by the user, is a measure of the user's “publishing” connectivity. This component reflects the ability of the user to publish public content that has a wide distribution. This component is measured or determined by using publicly available ranking scores for user generated media (e.g., blog rankings, website rankings, etc.). Alternatively or additionally, MCS 17 may register its bulletin board and blog provider services with score provider 18 to provide the on-line user generated publishing information associated with the user to the score provider. In a manner similar to web search algorithms, web crawlers can aggregate this information periodically. The on-line user generated publishing information associated with a user is based on several sub-components such as number of posts (blogs, groups, forums, listservs, Reviews); relative popularity of blog posts or user reviews (user ratings, relative popularity of blogs); the relative popularity of the blogs of the other users who link to those blogs; relative popularity of user reviews (uses ratings and rankings); personal website Alexa rankings; blog page views; and relative popularity of these forums. Score provider 18 may weigh these sub-components making up the on-line user generated publishing component differently. Again, these on-line user generated publishing sub-components are measured based on publicly available ranking scores for user generated media (e.g., blog rankings, website rankings)—all of the blog information and rankings are publicly available.

In sum, as shown in block 26, score provider 18 assigns a customer influence ranking score to a user of a user device as a function of the two components or variables: (i) the social networking breadth of the user and (ii) the reach (relevance) of on-line publishing generated by the user. Score provider 18 may weigh these components evenly or unevenly. Further, score provider 18 may adjust the weighting between these two components over time. Score provider 18 may use additional factors to determine the customer influence ranking score for the user. As such, a user is able to increase its customer influence ranking score by becoming more connected with other users. For example, an on-line user can become more connected with other users by joining more on-line networks and being more interconnected to other users of these networks (i.e., increasing the user's social networking breadth). Likewise, for example, an on-line user can become more connected with other users by having a greater reach and relevancy of their user generated content as a result of posting on more customer forum sites, joining more on-line groups, creating a blog, linking to popular blogs and in turn becoming more popular and influential, etc. (i.e., increasing the user's reach and relevancy of its on-line publishing).

Score provider 18 performs the customer influence ranking score process to assign a customer influence ranking score to each of a plurality of users. Score provider 18 may then assign customer influence ranking scores as absolute numbers to each user. Score provider 18 may perform distribute the customer influence ranking scores of the users into performance bands, for example, and the universe of users assigned such scores are ranked according to their scores with the top 20% getting the highest score, the next 20% getting the next score, and so on.

Score provider 18 may then identify the users having the highest customer influence ranking scores as shown in block 28. In turn, score provider 18 may provide knowledge regarding the users which have the highest customer influence ranking scores to sellers of goods and services as shown in block 30. The sellers can offer (on-line) purchase discounts to the users having the highest customer influence ranking scores.

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A method for assigning ranking scores to Internet users of a networking site and a content site, wherein the networking site enables each user to become associated with one or more other users as friends, wherein the content site enables each user to rate content published on the content site by other users, the method comprising:
obtaining data indicative of the friends of each user from the networking site;
assigning a network popularity rating to each user based on the amount of friends of the user;
obtaining data indicative of the ratings assigned to the published content of the users from the content site;
assigning a content popularity rating to each user based on the ratings of the content published by the user;
assigning a ranking score to each user based on the network popularity rating and the content popularity rating of the user; and
providing the ranking scores of the users to a third party.

2. The method of claim 1 wherein:
the ranking score assigned to each user is based on an even weighting of the network popularity rating and the content popularity rating of the user.

3. The method of claim 1 wherein:
the ranking score assigned to each user is based on an uneven weighting of the network popularity rating and the content popularity rating of the user.

4. The method of claim 1 wherein the networking site provides personal network sites such that users belonging to the same personal network site are direct friends, wherein each user belonging to a personal network site and each user belonging to a different personal network site are indirect friends if the two users have a common friend, wherein:
assigning a network popularity rating to a user includes assigning the network popularity rating to the user based on the amount of direct and indirect friends of the user.

5. The method of claim 4 wherein:
the amount of direct friends of a user influences the network popularity rating assigned to the user more than the amount of indirect friends of the user.

6. The method of claim 1 wherein:
assigning a content popularity rating to a user includes assigning the content popularity rating to the user based on the ratings of the content published by the user and on the ratings of the content published by the users rating the content published by the user.

7. The method of claim 1 further comprising:
obtaining data indicative of the amount of content published by each user from the content site;
wherein assigning a content popularity rating to each user is based on the ratings of the content published by the user and the amount of content published by the user.

8. The method of claim 1 further comprising:
the third party contacting the users having desired ranking scores to provide these users with goods or services offered by the third party.

9. A system for assigning ranking scores to Internet users, the system comprising:
a social network server for providing a social networking site for use by Internet users, wherein the social networking site enables each user to become associated with one or more other users as friends;
a media content server for providing a media content site for use by the users, wherein the media content site enables each user to publish content for the other users to view, wherein the media content site enables each user to rate the content published by other users; and
a score provider server in communication with the social network server to enable a score provider to obtain a first set of data indicative of the friends of each user, wherein the score provider assigns a social network popularity rating to each user based on the amount of friends of the user;
wherein the score provider server is in communication with the media content server to enable the score provider to obtain a second set of data indicative of the ratings assigned to the published content of the users, wherein the score provider assigns a media content popularity rating to each user based on the ratings of the content published by the user;
wherein the score provider assigns a ranking score to each user based on the social network popularity rating and the media content popularity rating of the user and provides the ranking score of the users to a third party.

10. The system of claim 9 wherein:
the score provider obtains the data from the social networking site and the media content site via a web crawler.

11. A system for assigning ranking scores to Internet users, the system comprising:
a social network server for providing a social networking site for use by Internet users, wherein the social networking site enables each user of the social networking site to become associated with one or more other users of the social networking site as friends;
a media content server for providing a media content site for use by Internet users, wherein the media content site enables each user of the media content site to publish content for the other users of the media content site to view, wherein the media content site enables each user of the media content site to rate the content published by other users of the media content site; and
a score provider server in communication with the social network server to enable a score provider to obtain a first set of data indicative of the friends of each user of the social networking site, wherein the score provider assigns a social network popularity rating to each user based on the amount of friends of the user;
wherein the score provider server is in communication with the media content server to enable the score provider to obtain a second set of data indicative of the ratings assigned to the published content of the users of the media content site, wherein the score provider assigns a media content popularity rating to each user of the media content site based on the ratings of the content published by the user;
wherein the score provider assigns a ranking score for each user who is a user of the social network site and the media content site based on the social network popularity rating and the media content popularity rating of the user and provides the ranking score of a user to a third party.

12. The system of claim 11 wherein:
the score provider determines the ranking score for each user based on an even weighting of the social network popularity rating and the media content popularity rating of the user.

13. The system of claim 11 wherein:
the score provider determines the ranking score for each user based on a different weighting of the social network popularity rating and the media content popularity rating of the user.

14. The system of claim 11 wherein:
the score provider determines a first ranking score component for each user of the social network site based on the social network popularity rating of the user.

15. The system of claim 14 wherein:
the score provider determines a second ranking score component for each user of the media content site based on the media content popularity rating of the user.

16. The system of claim 15 wherein:
the score provider assigns a ranking score to a user based on each ranking score component assigned to the user.

17. The system of claim 11 wherein:
the social networking site provides personal social network sites such that users belonging to the same personal social network site are direct friends, wherein each user belonging to a personal social network site and each user belonging to a different personal social network site are indirect friends if the two users have a common friend;
wherein the score provider assigns the social network popularity rating to each user of the social networking site based on the amount of direct friends of the user and the amount of indirect friends of the user.

18. The system of claim 17 wherein:
the amount of direct friends of a user influences the social network popularity rating assigned to the user more than the amount of indirect friends of the user.

19. The system of claim 11 wherein:
the score provider assigns the media content popularity rating to each user of the media content site based on the ratings of the content published by the user and on the ratings of the content published by the users rating the content published by the user.

20. The system of claim 11 wherein:
the score provider obtains the from the social networking site and the media content site via a web crawler.
